(19) United States
(12) Patent Application Publication
(10) Pub. No.: US 2025/0271547 A1
(43) Pub. Date: Aug. 28, 2025

(54) ENVIRONMENT SENSOR TESTING DEVICE, TEST ASSEMBLY FOR AN ENVIRONMENT SENSOR, AND METHOD FOR OPERATING THE ENVIRONMENT SENSOR TESTING DEVICE

(71) Applicant: dSPACE GmbH, Paderborn (DE)

(72) Inventor: Niklas LANGE, Paderborn (DE)

(21) Appl. No.: 19/058,058

(22) Filed: Feb. 20, 2025

(30) Foreign Application Priority Data
Feb. 22, 2024 (DE) 102024104982.0

(51) Int. Cl. G01S 7/40; G01S 7/497

(52) U.S. Cl. CPC G01S 7/40; G01S 7/497

(57) ABSTRACT

An environment sensor testing device includes: a receiver configured to: receive a first environment signal from an environment sensor under test; and convert the first environment signal into a first working signal; a digital component configured to: convert the first working signal into a first digital signal; change the first digital signal into a second digital signal on the basis of a test scenario; link the second digital signal to a third digital signal in order to form a fourth digital signal, wherein the third digital signal is dependent on a specification; and convert the fourth digital signal into a second working signal; and a transmitting device configured to: convert the second working signal into a second environment signal; and send it to the environment sensor. The third digital signal corresponds to at least one interference signal from a source of interference for the second working signal.

### CROSS-REFERENCE TO PRIOR APPLICATIONS

This application claims benefit to German Patent Application No. DE 102024104982.0, filed on Feb. 22, 2024, which is hereby incorporated by reference herein.

### FIELD

The application relates to an environment sensor testing device and to a method for operating an environment sensor testing device of this kind. The application further relates to a test assembly for an environment sensor.

### BACKGROUND

By way of example, an environment sensor can be formed as a vehicle sensor that operates using electromagnetic waves. Examples of vehicle sensors of this kind are radar sensors or LiDAR sensors. An environment sensor testing device can be used, for example, as an object simulator for a vehicle sensor of this kind.

### SUMMARY

In an exemplary embodiment, the present invention provides an environment sensor testing device. The environment sensor testing device includes: a receiving device configured to: receive a first environment signal from an environment sensor under test; and convert the first environment signal into a first working signal: a digital component configured to: convert the first working signal into a first digital signal: change the first digital signal into a second digital signal on the basis of a test scenario; link the second digital signal to a third digital signal in order to form a fourth digital signal, wherein the third digital signal is dependent on a specification: and convert the fourth digital signal into a second working signal: and a transmitting device configured to: convert the second working signal into a second environment signal; and send it to the environment sensor. The third digital signal corresponds to at least one interference signal from a source of interference for the second working signal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a block diagram of a test assembly;

FIG. 2 schematically shows a block diagram of an environment sensor testing device; and

FIG. 3 is a schematic flowchart of a method for operating the environment sensor testing device.

In the drawings, the same reference signs are used for the same or similar elements. The depictions in the drawings may not be to scale.

### DETAILED DESCRIPTION

In an embodiment, an environment sensor testing device comprises a receiving device, a digital component, and a transmitting device.

The receiving device is configured to receive a first environment signal from an environment sensor under test, and to convert the first environment signal into a first working signal.

The digital component is configured to convert the first working signal into a first digital signal, and to change the first digital signal into a second digital signal on the basis of a test scenario. The digital component is further configured to link the second digital signal to a third digital signal in order to form a fourth digital signal, the third digital signal being dependent on a specification. The digital component is further configured to convert the fourth digital signal into a second working signal.

The transmitting device is configured to convert the second working signal into a second environment signal and to send it to the environment sensor.

In this case, the third digital signal corresponds to at least one interference signal from a source of interference for the second working signal. The third digital signal is thus configured such that it alters the second working signal in the same way as the source of interference would in the environment of the environment sensor.

A method for operating the environment sensor testing device comprises the following method steps:
receiving a first environment signal from an environment sensor under test,
converting the first environment signal into a first working signal,
converting the first working signal into a first digital signal,
changing the first digital signal into a second digital signal on the basis of a test scenario,
combining the second digital signal with a third digital signal in order to form a fourth digital signal, the third digital signal being dependent on a specification,
converting the fourth digital signal into a second working signal,
converting the second working signal into a second environment signal,
sending the second environment signal to the environment sensor.

In this case, the third digital signal is generated such that, after the combination with the second digital signal and the conversion into the fourth digital signal and the second working signal, it is depicted in the second working signal as at least one interference signal from a source of interference. The third digital signal thus corresponds to at least one interference signal from a source of interference in the environment of the environment sensor.

The environment sensor testing device and the corresponding method therefore have the advantage whereby an artificial digital noise signal is added in the digital component. Thus, it is simple to add such noise signals or interference signals in any configuration. In particular, the third digital signal can represent an environment signal of one or more transmitters. In this case, the third digital signal can be added purely digitally, meaning that an analog signal generator is not needed. A realistic simulation is thus possible for the environment sensor. This can enhance the development quality of the environment sensor for when it is used in the vehicle.

The environment sensor testing device allows environment sensors, for example a radar or LiDAR sensor, to undergo a wide range of test scenarios in the laboratory. This saves on test journeys for vehicles having the environment sensor. For this purpose, the environment sensor testing device can simulate surroundings of the environment sensor and/or of the vehicle.

To this end, the environment sensor testing device comprises the receiving device, which receives the first environment signal from the environment sensor under test. For this purpose, in cases where the environment sensor is a radar sensor, for example, a receiving antenna and an analog receiving component are provided. The receiving device comprises the analog receiving component. In this case, corresponding high-frequency circuits such as amplifiers, filters, and mixers are provided. The first environment signal is converted into the first working signal in the receiving device. The first working signal is an analog signal.

By way of example, the receiving device is connected to the digital component via an analog-to-digital converter of the digital component. The digital component comprises the analog-to-digital converter. The first working signal is converted into the first digital signal by the analog-to-digital converter.

By way of example, the digital component can be in the form of a so-called FPGA (field programmable gate array) or comprise digital circuits in combination with one or more processors or simply comprise one or more processors.

The first digital signal is then changed into the second digital signal in the digital component on the basis of the test scenario. The test scenario indicates, for example, which objects with which properties are supposed to be located where in the field of view of the environment sensor under test. This forms the basis for simulating these objects. Then, using the test scenario, a signal reflected in accordance with these simulated objects is generated in the digital component as a second digital signal out of the first digital signal.

The second digital signal is linked to the third digital signal in order to form the fourth digital signal. The linking can involve combining the two signals, for example by addition or multiplication. The third digital signal corresponds to an interference signal or noise signal from one or more sources of interference or (interfering) transmitters. The interference signal is generated virtually by the digital component in the form of the third digital signal. In this case, the third digital signal comprises at least some portions that correspond to the interference signal or noise signal from one or more sources of interference or (interfering) transmitters. It is also possible for the third digital signal to have other signal portions.

The third digital signal is linked to the fourth digital signal on the basis of the specification. In this case, the specification may change dynamically while the environment sensor testing device is in operation, in particular while the environment sensor is being tested. In particular, the specification can change independently of the test scenario.

If the environment sensor comprises a LiDAR sensor. then the receiving device has a corresponding optical receiver. The first environment signal accordingly comprises the optical signal emitted by the LiDAR sensor under test. The receiving device converts the received optical signal into an electrical signal as the first working signal and then outputs the first working signal to the digital component via the analog-to-digital converter of the digital component. The analog-to-digital converter converts the first working signal into the first digital signal. The third digital signal then corresponds to an optical interference signal or noise signal from one or more light transmitters as sources of interference. Within the context of this application. this means that the third digital signal comprises a signal portion that corresponds to the at least one interference signal. These interference signals are generated virtually by the digital component in the form of the third digital signal. This noise signal thus represents a light signal from other LiDAR sensors or other optical transmitters that output their respective light signals on the same or similar wavelengths as the environment sensor to be tested.

Furthermore, the environment sensor testing device comprises a transmitting device that converts the fourth digital signal into a second working signal. the digital component comprising a digital-to-analog converter that converts the fourth digital signal into the second working signal. The second working signal is an analog signal. The transmitting device can further process the second working signal using a frequency shifter. mixers. and amplifiers. and can then convert it into a second environment signal. Changes to the fourth digital signal made to the second working signal by the transmitting device downstream of the digital-to-analog converter can be taken into account when the third digital signal is linked to the second digital signal in order to form the fourth digital signal. For example. the changes can be taken into account inversely beforehand in the analog transmitting component.

The second environment signal is then sent by the transmitting device. Where the environment sensor is a radar sensor. the second environment signal is sent via a transmitting antenna. and where the environment sensor is a LiDAR sensor, it is sent via an optical transmitter such as a laser or an LED.

In one embodiment. the third digital signal is generated by the digital component on the basis of the specification or is loaded from a memory of the digital component on the basis of the specification. It is thus possible for the third digital signal to be loaded from a memory according to the specification. in which case a library of such noise signals has already been created in advance and the third digital signal is loaded from the memory in accordance with the specification. It is also possible for the third digital signal to be generated by the digital component. This requires computing power but saves on storage capacity. As a result, the third digital signal can also correspond to any noise signals, unlike with a library in which it is limited to the content of that library. Mixed forms are also conceivable, in which, for example, contents of the library are generated dynamically by the digital component.

In one embodiment, the source of interference comprises at least one further environment sensor and/or the at least one interference signal comprises at least one further environment signal from the at least one further environment sensor. As a result, the virtual transmitter that issues the interference signal can be a different environment sensor, for example attached to a different vehicle or to a piece of infrastructure that can also comprise environment sensors of this kind. Other transmit signals, emitted for example by a Wi-Fi transmitter, can also be interference signals of this kind.

In one embodiment, the test scenario comprises at least one object to be simulated in the environment of the environment sensor. The environment sensor testing device simulates the at least one object in the environment of the environment sensor, the changing of the first digital signal into the second digital signal being dependent on the test scenario comprising the at least one object to be simulated. Alternatively, it is possible for the test scenario to not contain any object, in which case the second digital signal is a zero signal, i.e. the first environment signal emitted by the environment sensor under test is not reflected on an object. In this case, only the interference signal might be sent back to the environment sensor.

In embodiments, an input device (also referred to herein as an input) for inputting input data can furthermore be provided. In this case, the specification depends on the input data. Thus, a user using the environment sensor testing device for testing the environment sensor can make corresponding inputs in order to shape the specification according to which the noise signal of the transmitter is to be formed. The input can also be done automatically, for example by inputting interference scenarios. As a result, any interference scenarios can be superimposed on the test scenario.

In embodiments, a signal shape may have been pre-registered by the environment sensor testing device or a further environment sensor testing device in real-world or simulated test scenarios and may be predeterminable as an interference signal.

In one embodiment, the specification comprises a number of sources of interference and/or at least one type of source of interference and/or at least one signal parameter of each interference signal. Types of sources of interference may include whether the sources of interference are other environment sensors or transmitters of the infrastructure or the like. The signal parameters can comprise, for example, the frequency, amplitude, phase, type of modulation, or the like. In particular, the number of (interfering) transmitters and/or at least one type of the at least one (interfering) transmitter and/or at least one signal parameter of each further environment signal can be specified by the specification. It is thus possible to precisely specify the noise signal of the at least one transmitter using the specification. By way of example, the amplitude, frequency, and phase of the signal, and the type of modulation can be defined as signal parameters. The type of the at least one transmitter can be understood, for example, as a particular type from a radar sensor or LiDAR sensor manufacturer. In addition, it can be provided that the at least one respective signal parameter more precisely defines the type of modulation and, for example, comprises parameters that describe a chirp signal in which the frequency of the signal changes over time.

Optionally, the specification can further include whether the source of interference is moving or stationary. Movement can have an impact owing to the Doppler effect, for example.

In embodiments, the digital component can be in the form of an FPGA. FPGAs are integrated circuits in which a logic circuit can be loaded. FPGAs can be programmed flexibly using gates. Moreover, for example, they generally offer quicker computation compared with a processor-based software solution.

In addition, a test assembly for an environment sensor is provided, the test assembly comprising the above-described environment sensor testing device and a holder for the environment sensor. The holder is provided for holding and suitably positioning the environment sensor under test for the purpose of the test so that the environment sensor is in a defined geometric arrangement in relation to the environment sensor testing device.

FIG. 1 schematically shows a block diagram of a test assembly TA. The test assembly TA comprises a holder AUF for an environment sensor RUT, for example a radar sensor, and an environment sensor testing device DARTS.

The environment sensor RUT outputs a first environment signal U1, the first environment signal U1 being received by a receiving antenna A1 of an environment sensor testing device DARTS. The receiving antenna A1 can be in the form of a horn antenna, a phased array antenna, or another type of antenna. In addition, a wired connection, for example using a waveguide, is conceivable.

The environment sensor testing device DARTS alters the received first environment signal U1 in accordance with a test scenario and emits the second environment signal U2 via a transmitting antenna A2. The transmitting antenna A2 can be in the form of a horn antenna, a phased array antenna, or another type of antenna. The receiving antenna A1 and the transmitting antenna A2 can be combined in one antenna.

The second environment signal U2 can be received by the environment sensor RUT. The test scenario indicates the simulated object(s) on which the first environment signal is reflected. Simulated objects are, for example, other road users in the surroundings of the environment sensor RUT, such as vehicles or pedestrians. Simulated objects can also comprise the actual surroundings of the environment sensor RUT, i.e., streets, buildings, infrastructure, or the like.

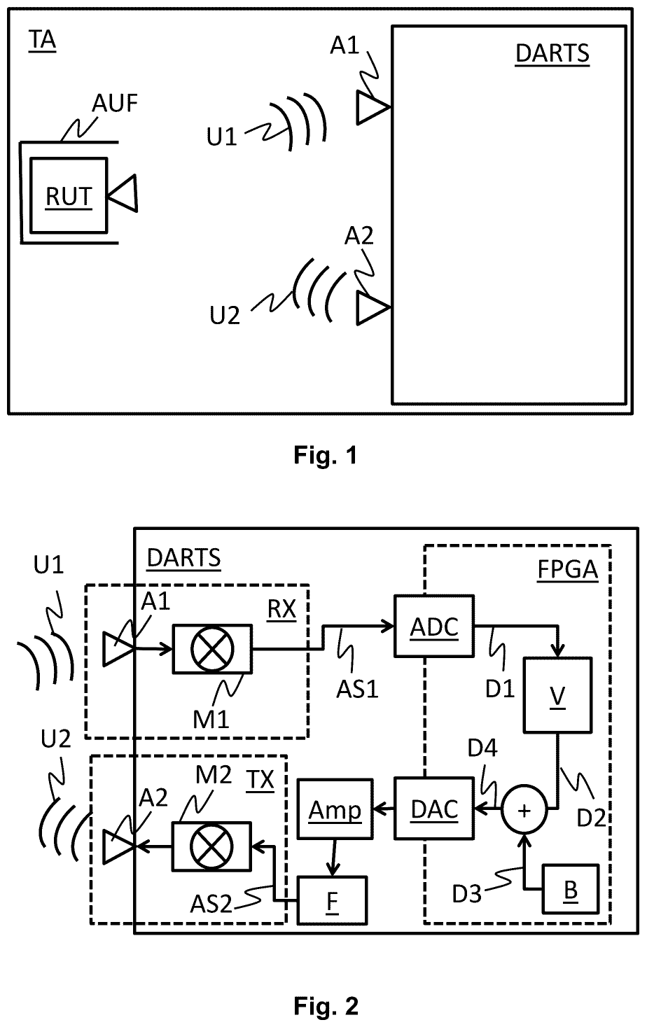

FIG. 2 schematically shows a block diagram of the environment sensor testing device DARTS.

The environment sensor testing device DARTS converts the received first environment signal U1 into a first working signal AS1, which is then converted into a first digital signal D1 and changed into a second digital signal D2 in accordance with the test scenario. The second digital signal D2, which results from the first digital signal D1 and the test scenario, represents the signal reflected in the area surrounding the environment sensor RUT. In this case, the surrounding area is defined in the test scenario.

Next, the second digital signal D2 is combined with a third digital signal D3. The two signals can be combined by. for example, adding the second and third digital signals D2, D3 together or multiplying the second and third digital signals D2, D3. On the basis of a specification, the third digital signal D3 corresponds to at least one further interference signal from at least one source of interference. In this context, “corresponds to” means that the third digital signal D3 comprises signal portions that act like an interference signal in an emitted second environment signal U2 after the conversion steps.

Besides the environment sensor RUT, a source of interference, for example another environment sensor, likewise outputs an interference signal, for example further environment signals, which can constitute noise signals for the environment sensor RUT in the same frequency range as the first environment signal U1. This can lead to interference that has to be taken into account by the environment sensor RUT in order to fulfill its purpose, i.e., capturing the environment. It is therefore advantageous to identify these noise signals and eliminate or at least limit their impact.

From a fourth digital signal D4—which results from a combination of the second and third digital signals D2, D3—a second working signal AS2 is then generated in the environment sensor testing device DARTS, and a second environment signal U2 is generated therefrom. The second environment signal U2 is sent to the environment sensor RUT via the transmitting antenna A2.

The receiving antenna A1 and the transmitting antenna A2 can be embodied in a single antenna. It is possible for the antennas A1 and A2 to be horn antennas or antenna arrays. Other types of antennas are also possible.

The environment sensor testing device DARTS comprises an analog high-frequency component. which consists of the receiving device (also referred to herein as a receiver) RX and the transmitting device (also referred to herein as a transmitter) TX. Both the receiving device RX and the transmitting device TX are connected to the digital component FPGA. The connection from the receiving device RX to the digital component FPGA is ensured via an analog-to-digital converter ADC. and the connection from the digital component FPGA to the transmitting device TX is ensured via a digital-to-analog converter DAC. In the embodiment example shown. the two converters ADC and DAC are part of the digital component FPGA. Alternatively, it is possible to assign them to the receiving device RX and the transmitting device TX. respectively. or also to consider them as separate components.

The first environment signal U1 is received by the antenna A1. In the receiving device RX. it is then downmixed by a first mixer M1 to form a first working signal AS1. For this purpose. for example. heterodyne or superheterodyne receivers can be used. Amplifiers. filters. and further mixers are not shown for reasons of simplicity.

This first working signal AS1 is input into the analog-to-digital converter ADC. which generates the first digital signal D1 from the first working signal.

From the first digital signal D1. the second digital signal D2 is formed by the processing module V according to a test scenario. The processing module can be a delay line. a module for influencing the amplitude. or a frequency shifter. This test scenario indicates the simulated surroundings to the environment sensor RUT. These surroundings determine whether and how the first environment signal U1 is reflected. If the surroundings are empty. the second digital signal D2 is a zero signal because in that case the signal is not reflected on any object. The test scenario can be loaded from a memory and also used multiple times while the environment sensor RUT is being tested. In particular. it is possible for the test scenario to be able to be altered by an input. for example via an input unit.

By way of example. the second digital signal D2 is combined with the third digital signal D3 by addition or multiplication. This third digital signal D3 is loaded from a memory B. The memory B can comprise a library. a specific third digital signal D3 being loaded from the library according to the specification. The specification can be input and/or altered by an input. for example via an input unit. In this case, the specification is in particular independent of the test scenario and can be altered independently of the test scenario.

The library comprises different interference scenarios depicting, in particular, interfering scenarios in which, for example, a number of interfering transmitters, their type. and their signal parameters are specified. This is then expressed in the noise signal and thus in the third digital signal D3. Alternatively or additionally, it is possible for the third digital signal D3 to be generated by the digital component FPGA according to the specification in order for it to be combined with the second digital signal D2 to form the fourth digital signal D4.

The fourth digital signal D4 is then converted into the second working signal AS2 by a digital-to-analog converter DAC. The second working signal AS2 is shaped by an amplifier Amp and a frequency shifter F. the second working signal AS2 then being upmixed in a second mixer M2 to form a second environment signal U2 in order for it then to be sent as the second environment signal U2 via the transmitting antenna A2.

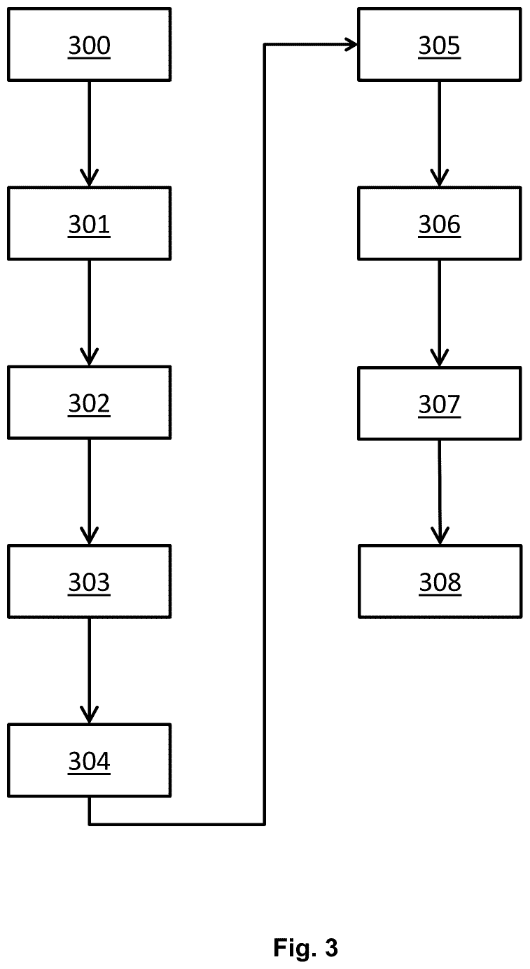

FIG. 3 is a schematic flowchart of the method for operating the environment sensor testing device DARTS.

In method step 300, the first environment signal U1 of the environment sensor RUT under test is received by the environment sensor testing device DARTS via the receiving antenna A1.

In method step 301, the first environment signal U1 is converted into the first working signal AS1 via the first mixer M1.

In method step 302, the first working signal AS1 is converted into the first digital signal D1 by the analog-to-digital converter ADC.

In method step 303, the first digital signal D1 is changed into the second digital signal D2 on the basis of the test scenario.

In method step 304, the third digital signal D3 is loaded from the memory B in accordance with the specification, or the third digital signal D3 is generated by the digital component FPGA in accordance with the specification. In this case, the third digital signal D3 corresponds to at least one interference signal from at least one source of interference.

In method step 305, the second digital signal D2 is combined with the third digital signal D3 in order to form the fourth digital signal D4.

In method step 306, the fourth digital signal D4 is converted into the second

working signal AS2. Optionally, the second working signal AS2 is amplified by the amplifier Amp and manipulated in terms of frequency by the frequency shifter F.

In method step 307, the second working signal AS2 is converted into the second environment signal U2 by the second mixer M2.

In method step 308, the second environment signal U2 is sent to the environment sensor RUT via the antenna A2.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

TA Test assembly
DARTS Environment sensor testing device
FPGA Digital component
AUF Holder
RUT Environment sensor
A1 First antenna
A2 Second antenna
U1 First environment signal
U2 Second environment signal
M1 First mixer
M2 Second mixer
RX Receiving device
TX Transmitting device
AS1 First working signal
AS2 Second working signal
Amp Amplifier
V Processing module
F Frequency shifter
D1 First digital signal
D2 Second digital signal
D3 Third digital signal
D4 Fourth digital signal
B Memory
ADC Analog-to-digital converter
DAC Digital-to-analog converter
300-308 Method steps

1. An environment sensor testing device, comprising:
a receiver configured to:
receive a first environment signal from an environment sensor under test; and
convert the first environment signal into a first working signal;
a digital component comprising digital circuits or one or more processors configured to:
convert the first working signal into a first digital signal;
change the first digital signal into a second digital signal on the basis of a test scenario;
link the second digital signal to a third digital signal in order to form a fourth digital signal, wherein the third digital signal is dependent on a specification; and
convert the fourth digital signal into a second working signal; and
transmitter configured to:
convert the second working signal into a second environment signal; and
send it to the environment sensor;
wherein the third digital signal corresponds to at least one interference signal from a source of interference for the second working signal.

2. The environment sensor testing device according to claim 1, wherein the digital component is configured to generate the third digital signal on the basis of the specification or to load the third digital signal from a memory on the basis of the specification.

3. The environment sensor testing device according to claim 1, wherein the source of interference comprises at least one further environment sensor; and/or
wherein the at least one interference signal comprises at least one further environment signal from at least one further environment sensor.

4. The environment sensor testing device according to claim 1, wherein the test scenario comprises at least one object that is to be simulated in the environment of the environment sensor;
wherein the environment sensor testing device is configured to simulate the at least one object in the environment of the environment sensor; and
wherein the changing of the first digital signal into the second digital signal is dependent on the at least one object to be simulated.

5. The environment sensor testing device according to claim 1, further comprising:
an input configured for inputting input data, wherein the specification is dependent on the input data.

6. The environment sensor testing device according to claim 1, wherein the specification comprises:
a number of sources of interference,
at least one type of source of interference, and/or
at least one signal parameter of each interference signal.

7. The environment sensor testing device according to claim 1, wherein the specification includes whether the source of interference is moving or stationary.

8. The environment sensor testing device according to claim 1, wherein the environment sensor testing device is configured for testing a radar sensor and/or a LiDAR sensor.

9. The environment sensor testing device according to claim 1, wherein the digital component is configured as a field programmable gate array (FPGA).

10. A test assembly for an environment sensor, wherein the test assembly comprises:
a receiver configured to:
receive a first environment signal from an environment sensor under test; and
convert the first environment signal into a first working signal;
a digital component comprising digital circuits or one or more processors configured to:
convert the first working signal into a first digital signal;
change the first digital signal into a second digital signal on the basis of a test scenario;
link the second digital signal to a third digital signal in order to form a fourth digital signal, wherein the third digital signal is dependent on a specification; and
convert the fourth digital signal into a second working signal;
a transmitter configured to:
convert the second working signal into a second environment signal; and
send it to the environment sensor; and
a holder for the environment sensor.

11. A method for operating an environment sensor testing device, comprising:
receiving a first environment signal from an environment sensor under test,
converting the first environment signal into a first working signal;
converting the first working signal into a first digital signal;
changing the first digital signal into a second digital signal on the basis of a test scenario;
combining the second digital signal with a third digital signal in order to form a fourth digital signal, wherein the third digital signal is dependent on a specification;
converting the fourth digital signal into a second working signal;
converting the second working signal into a second environment signal; and
sending the second environment signal to the environment sensor;
wherein the third digital signal corresponds to at least one interference signal from a source of interference for the second working signal.

12. The method according to claim 11, wherein the third digital signal is generated on the basis of the specification or is loaded from a memory on the basis of the specification.

13. The method according to claim 11, wherein the source of interference comprises at least one further environment sensor; and/or
wherein the at least one interference signal comprises at least one further environment signal from the at least one further environment sensor.

14. The method according to claim 11, further comprising:
receiving input data via an input device, wherein the specification is dependent on the input data.

15. The method according to claim 11, wherein the specification comprises;
a number of sources of interference,
at least one type of source of interference, and/or
at least one signal parameter of each interference signal.
